(19) United States
(12) Patent Application Publication
(10) Pub. No.: US 2026/0071552 A1
(43) Pub. Date: Mar. 12, 2026

(54) LAP JOINTED LONGITUDINAL/AXIAL FLANGES FOR CIRCUMFERENTIALLY FLANGED COMPOSITE COMPONENTS IN THE FORM OF HOLLOW SINGLE/MULTI-CYLINDERS, SINGLE/MULTI-ANGLE CONICAL FRUSTRUMS OR A COMBINATION THEREOF

(71) Applicant: RTX Corporation, Farmington, CT (US)

(72) Inventors: Robert White, III, Meriden, CT (US); Farruqh Shahab, East Hartford, CT (US)

(73) Assignee: RTX Corporation, Farmington, CT (US)

(21) Appl. No.: 18/827,058

(22) Filed: Sep. 6, 2024

(51) Int. Cl. F01D 25/00

(52) U.S. Cl. CPC F01D 25/00; F05D 2230/60; F05D 2300/603

(57) ABSTRACT

A lap jointed flanged composite component including a first end opposite a second end with respect to an axis; a first segment coupled with a second segment to form the composite component; the first segment includes a first flange on at least one of the first end and the second end; the second segment includes a second flange on at least one of the first end and the second end; the first flange and the second flange being combined together at a butt joint forming a circumferential flange with respect to the axis; and a lap joint overlapping of the first segment with the second segment proximate the butt joint.

### BACKGROUND

The present disclosure is directed to the improved lap jointed flanged composite component.

Advanced composite components (e.g., polymer matrix composite, (PMC), metal matrix composite (MMC), ceramic matrix composite (CMC)) for use in performance gas turbine engine applications is a relatively new design concept that is being explored for low/high pressure compressor (LPC/HPC), low/high pressure turbine (LPT/HPT), fan bypass, combustor, and nozzle environments.

In many instances, as with axisymmetric parts that are circumferentially segmented, additional attachments (such as longitudinal/axial flanges) are required to join the segments. This can be challenging due to the presence of the necessary circumferential flanges, and in some cases, butt joints may be utilized along with bolted plate(s) that serve to bridge the gap.

However, this often leads to excess weight (fasteners are required on both the top and bottom of the plate(s) and the plate(s) themselves are often metallic). Moreover, the ability to replace legacy hardware (commonly metallic) with that of composites, as well as preserve the original hardware interfaces, often necessitates highly complex composite geometries, and alternate solutions must be available to accommodate this challenge.

### SUMMARY

In accordance with the present disclosure, there is provided a lap jointed flanged composite component comprising a first end opposite a second end with respect to an axis; a first segment coupled with a second segment to form the composite component; the first segment includes a first flange on at least one of the first end and the second end; the second segment includes a second flange on at least one of the first end and the second end; the first flange and the second flange being combined together at a butt joint forming a circumferential flange with respect to the axis; and a lap joint overlapping of the first segment with the second segment proximate the butt joint.

A further embodiment of any of the foregoing embodiments may additionally and/or alternatively include the first flange and the second flange extend radially outboard from an exterior surface of each of the first segment and the second segment respectfully.

A further embodiment of any of the foregoing embodiments may additionally and/or alternatively include the butt joint includes the first flange in direct flush contact with the second flange in the absence of overlap.

A further embodiment of any of the foregoing embodiments may additionally and/or alternatively include the circumferential flange is configured as a continuous circumferential flange on each of the first end and the second end of the composite component.

A further embodiment of any of the foregoing embodiments may additionally and/or alternatively include the lap joint connects the first segment with the second segment along a predetermined length of the composite component.

A further embodiment of any of the foregoing embodiments may additionally and/or alternatively include the lap jointed flanged composite component further comprising a transition region formed between the butt joint and the lap joint.

A further embodiment of any of the foregoing embodiments may additionally and/or alternatively include the lap jointed flanged composite component further comprising a stiffener proximate the lap joint.

In accordance with the present disclosure, there is provided a lap jointed flanged composite component for a gas turbine engine comprising a first end opposite a second end; a first segment coupled with a second segment; the first segment includes a first flange on at least one of the first end and the second end; the second segment includes a second flange on at least one of the first end and the second end; a butt joint formed at an intersection of the first flange and the second flange forming a circumferential flange with respect to an axis; a lap joint overlapping of the first segment with the second segment proximate the butt joint; and a transition region formed between the butt joint and the lap joint.

A further embodiment of any of the foregoing embodiments may additionally and/or alternatively include the first segment includes a first segment tab; the second segment includes a second segment tab; wherein the first segment tab overlaps the second segment tab within the lap joint a predetermined overlap dimension.

A further embodiment of any of the foregoing embodiments may additionally and/or alternatively include at least one of the first segment includes a first segment indentation and the second segment includes a second segment indentation.

A further embodiment of any of the foregoing embodiments may additionally and/or alternatively include the lap jointed flanged composite component for a gas turbine engine further comprising a stiffener proximate at least one of the butt joint and the lap joint.

A further embodiment of any of the foregoing embodiments may additionally and/or alternatively include the transition region includes a taper region comprising a thinning of a thickness of the first segment and/or the second segment.

A further embodiment of any of the foregoing embodiments may additionally and/or alternatively include the first flange and the second flange extend radially outboard from an exterior surface of each of the first segment and the second segment respectfully.

In accordance with the present disclosure, there is provided a process for forming a lap jointed flanged composite component for a gas turbine engine comprising forming a first end opposite a second end with respect to an axis; coupling a first segment with a second segment; forming a first flange on at least one of the first end and the second end of the first segment; forming a second flange on at least one of the first end and the second end of the second segment; combining the first flange and the second flange together at a butt joint; forming a circumferential flange with respect to the axis; and forming a lap joint by overlapping the first segment with the second segment proximate the butt joint.

A further embodiment of any of the foregoing embodiments may additionally and/or alternatively include the process further comprising forming a transition region between the butt joint and the lap joint.

A further embodiment of any of the foregoing embodiments may additionally and/or alternatively include the transition region includes a taper region comprising a thinning of a thickness of the first segment and/or the second segment.

A further embodiment of any of the foregoing embodiments may additionally and/or alternatively include the process further comprising forming the first segment with a first segment tab; forming the second segment with a second segment tab; and overlapping the first segment tab with the second segment tab within the lap joint a predetermined overlap dimension.

A further embodiment of any of the foregoing embodiments may additionally and/or alternatively include at least one of the first segment includes a first segment indentation and the second segment includes a second segment indentation.

A further embodiment of any of the foregoing embodiments may additionally and/or alternatively include the process further comprising attaching a stiffener proximate at least one of the butt joint and the lap joint.

A further embodiment of any of the foregoing embodiments may additionally and/or alternatively include the process further comprising joining the first segment with the second segment within the lap joint with a fastener.

This disclosure includes a solution to enable complex flange geometries on composites, specifically regarding cylindrically/conically-shaped composite components which possess both circumferential and longitudinal/axial flanges, and a method is proposed herein by employing a unique overlapping junction at the longitudinal/axial flange(s).

Other details of the lap jointed flanged composite component are set forth in the following detailed description and the accompanying drawings wherein like reference numerals depict like elements.

### BRIEF DESCRIPTION OF THE DRAWINGS

FIG. 1 is a schematic representation of an exemplary circumferentially flanged composite component in the form of a hollow cylinder.

FIG. 2 is a schematic representation of an exemplary lap joint region with stiffener of the circumferentially flanged component of FIG. 1.

FIG. 3 is a schematic representation of an exemplary butt joint region proximate a circumferential flange and the lap joint region of the circumferentially flanged component of FIG. 2.

FIG. 4 is a schematic representation of an exemplary transition region of FIG. 3.

FIG. 5 is a schematic representation of an exemplary transition region of FIG. 4.

FIG. 6 is a schematic representation of exemplary stiffener proximate the lap joint of FIG. 2.

### DETAILED DESCRIPTION

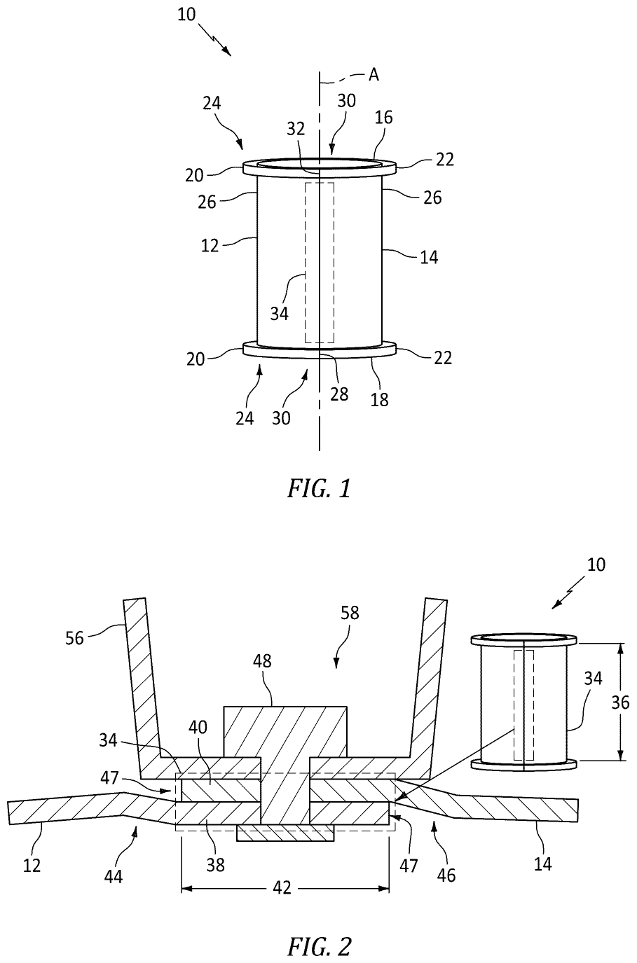

Referring now to FIG. 1, an exemplary composite component 10. The composite component 10 can be fabricated from any material, such as for example polymer matrix composite, (PMC), metal matrix composite (MMC), ceramic matrix composite (CMC)) for use in gas turbine engine applications. The composite component 10 can be employed in the gas turbine engine with a low/high pressure compressor (LPC/HPC), a low/high pressure turbine (LPT/HPT), a fan bypass, a combustor, and nozzle environments.

The composite component 10 is shown as a single hollow cylinder. It is contemplated that a variety of shapes can be employed to form the composite component 10. For example, the composite component 10 can be shaped as a hollow multi-cylinder shape, a single multi-angle conical frustrum, a multi-angle conical frustrum and the like. It is contemplated that axisymmetric configurations (e.g., cylindrical or conical geometry) implement simple flange geometries (primarily circumferential) as a means of transmitting engine load while simultaneously reducing the manufacturing complexity and structural uncertainty in what would otherwise need to be a highly complex laminate architecture.

The composite component 10 can include a first segment 12 coupled with a second segment 14. The first segment 12 and the second segment 14 can be joined together to form the composite component 10. It is contemplated that more than two segments can be employed to construct the composite component 10. The first segment 12 and the second segment 14 are shown as symmetrically shaped. It is contemplated that asymmetrical shapes can be employed. The first segment 12 and second segment 12 are being described as symmetrical halves for exemplary purposes.

The composite component 10 includes a first end 16 opposite a second end 18 with respect to an axis A. The first segment 12 includes a first flange 20 on each of the first end 16 and the second end 18. The second segment 14 includes a second flange 22 on each of the first end 16 and the second end 18. The first flange 20 and the second flange 22 are combined together as a circumferential flange 24 with respect to the axis A of the composite component 10. It is contemplated that in another exemplary embodiment, the first flange 20 and the second flange 22 can be formed as longitudinal flanges (not shown) depending on the style of the composite component 10. The first flange 20 and second flange 22 extend radially outboard from an exterior surface 26 of each of the first segment 12 and second segment 14 respectfully.

The composite component 10 includes a butt joint 28 proximate an area of contact, that is a butt joint region 30 of the first flange 20 and the second flange 22 joined together. The butt joint 28 includes the first flange 20 in direct flush contact with the second flange 22 in the absence of overlap. With the first flange 20 and the second flange 22 connected via a butt joint 28 on each of the flange faces 32, the circular flanges 20, 22 can form a continuous circumferential flange 24 on each of the first end 16 and second end 18 of the composite component 10.

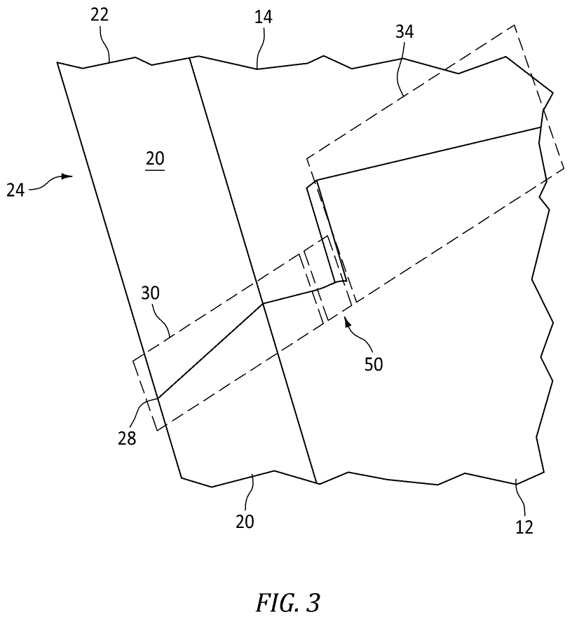

Referring also to FIG. 2 and FIG. 3, the composite component 10 can include a lap joint 34. The lap joint 34 includes the overlapping of the first segment 12 with the second segment 14. The lap joint 34 connects the first segment 12 with the second segment 14 along a length 36 of the composite component 10. The length 36 can extend between the first flange 20 and the second flange 22 along axis A. In an exemplary embodiment, the lap joint 34 can extend a portion of the length 36.

The first segment 12 includes a first segment tab 38. The second segment 14 includes a second segment tab 40. In the lap joint 34 the first segment tab 38 overlaps the second segment tab 40 a predetermined overlap dimension 42. The predetermined overlap dimension 42 can include a symmetrical overlap between the first segment tab 38 and the second segment tab 40. In an exemplary embodiment, the overlap can be asymmetrical.

The first segment 12 includes a first segment indentation 44. The second segment includes a second segment indentation 46. The first segment indentation 44 allows for the lap joint 34, since the first segment indentation 44 shifts the first segment tab 38 to overlap with the second segment tab 40. The second segment indentation 46 allows for the second segment tab 40 to overlap with the first segment tab 38. The lap joint 34 allows for the fist segment 14 to maintain the same circumference as the second segment 14 about the axis A. In the exemplary embodiment shown at FIG. 2, the first segment 12 has a larger circumference relative to the axis A within the lap joint 34 since the first segment tab 38 is exterior to the second segment tab 40 within the lap joint 34. It is contemplated that the first tab segment 38 and/or the second tab segment 40 can include a thinned thickness 47 by use of ply drop, (i.e., thinning the thickness) having less ply count and/or machining plies away. By altering the first segment tab 38 and/or the second segment tab 40 thickness dimensions 47, the circumference of the lap joint 34 can be equal to the circumference of proximate the first segment 12 and the second segment 14, making a uniform circumference for the composite component 10. In an alternative embodiment, it is contemplated that only one of the first segment 12 or the second segment 14 include an indentation 44, 46, while the other segment has no indentation feature. The first segment indentation 44 and/or the second segment indentation 46 can have equal magnitude or can be formed with unequal magnitudes.

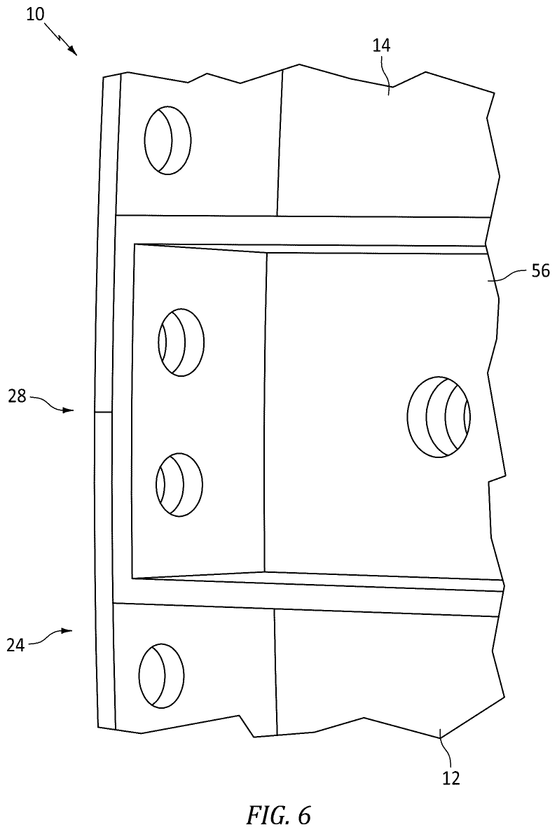

A fastener 48 can be employed to join the first segment 12 to the second segment 14 within the lap joint 34. In other embodiments, secondarily bonding, (i.e., adhesives) can be employed to join the tabs 38, 40 to secure the lap joint 34. The first segment 12 and second segment 14 can be joined at the lap joint by being co-cured, co-bonded, secondarily bonded and combinations thereof. As seen in FIG. 6, the lap joint allows for a single row of fasteners to affix the first segment 12 with the second segment 14, in contrast to a butt joint, where more than one row of fasteners would be needed.

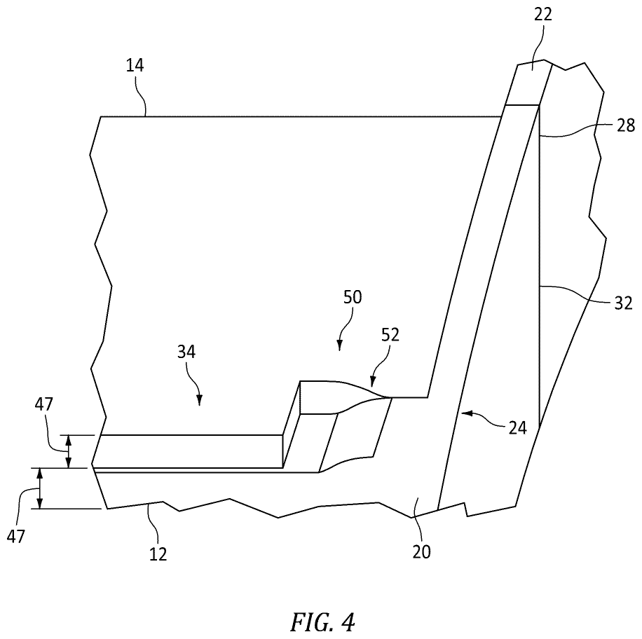

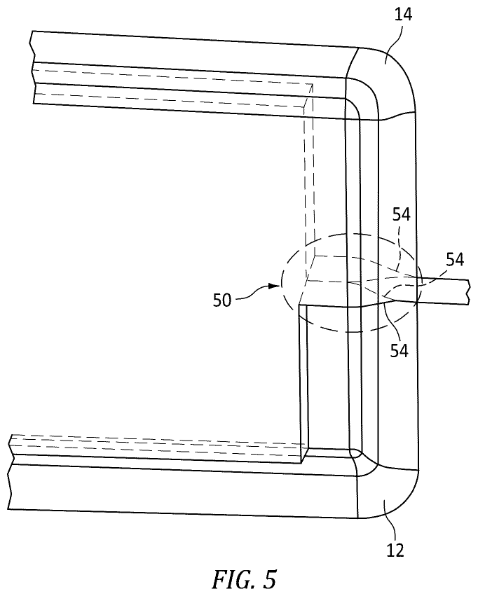

Referring also to FIG. 3 through FIG. 5, the butt joint region 30 is shown with the circumferential flange 24 formed by the union of the first flange 20 and second flange 22. Radially interior of the flange 24 a transition region 50 is formed between the butt joint region 30 and the lap joint region 34. The transition region 50 includes a taper region 52 that includes a thinning of the thickness 47 of the first segment 12 and/or the second segment 14. As discuss above, the first segment 14 and/or second segment 14 thickness 47 can have a ply drop proximate the transition region 50. Machining can be employed to thin the transition region 50 plies of both or either of the first segment 12 and second segment 14. The transition region 50 as shown includes the reduced thickness 47 and taper 54 of the plies within the composite component 10

Referring also to FIG. 6, a stiffener 56 can be employed with the composite component 10 proximate the lap joint 34. The stiffener 56 can be a separate multi-sided structure, such as a C-channel, U-channel, 5-sided box, and the like. The stiffener 56 can be configured to provide additional stiffness for the composite component 10. The stiffener 56 can support the lap joint 34 to preclude backbone bending, flange bending, torsion, panel/pressure vessel bulge and the like. It is contemplated that the stiffener 56 be integral to the circumferential flange 24, as seen in FIG. 6. The stiffener 56 can be constructed from the same materials as the composite component 10 such that the coefficients of thermal expansion match. Having the same materials can alleviate potential binding between the boundaries of the stiffener 56 and the circumferential flange 24 and/or limit inadvertent loading on the bolt stack 58. The stiffener 56 can be integrated into the lap joint 34 stack 58 as seen in FIG. 2.

A technical advantage of the disclosed lap jointed flanged composite component includes a structure for reducing weight.

Another technical advantage of the disclosed lap jointed flanged composite component includes a structure for increasing structural integrity.

Another technical advantage of the disclosed lap jointed flanged composite component includes a structure for simplifying the manufacture of structural composite components formed as hollow single/multi-cylinders, single/multi-angle conical frustums and the like.

Another technical advantage of the disclosed lap jointed flanged composite component includes a structure that enables the use of composite components that employ longitudinal flanges or adjoin multiple composite components with flanged features.

Another technical advantage of the disclosed lap jointed flanged composite component includes a technique that employs composite components in lieu of non-composite (metallic) engine hardware which possesses flanges, such as cases, ducts and liners.

Another technical advantage of the disclosed lap jointed flanged composite component includes a structure which improves producibility for complex laminate architectures.

Another technical advantage of the disclosed lap jointed flanged composite component includes increasing overall cost savings by limiting layup technology development and improving part quality.

Another technical advantage of the disclosed lap jointed flanged composite component includes the capacity to employ the design for similarly shaped components which are made from materials other than composites.

Another technical advantage of the lap jointed flanged composite component includes a means of improving upon current composite component design.

There has been provided a lap jointed flanged composite component. While the lap jointed flanged composite component has been described in the context of specific embodiments thereof, other unforeseen alternatives, modifications, and variations may become apparent to those skilled in the art having read the foregoing description. Accordingly, it is intended to embrace those alternatives, modifications, and variations which fall within the broad scope of the appended claims.

What is claimed is:

1. A lap jointed flanged composite component comprising:
a first end opposite a second end with respect to an axis;
a first segment coupled with a second segment to form the composite component;
the first segment includes a first flange on at least one of the first end and the second end;
the second segment includes a second flange on at least one of the first end and the second end;
the first flange and the second flange being combined together at a butt joint forming a circumferential flange with respect to the axis; and
a lap joint overlapping the first segment with the second segment proximate the butt joint.

2. The lap jointed flanged composite component according to claim 1, wherein the first flange and the second flange extend radially outboard from an exterior surface of each of the first segment and the second segment respectfully.

3. The lap jointed flanged composite component according to claim 1, wherein the butt joint includes the first flange in direct flush contact with the second flange in the absence of overlap.

4. The lap jointed flanged composite component according to claim 1, wherein the circumferential flange is configured as a continuous circumferential flange on each of the first end and the second end of the composite component.

5. The lap jointed flanged composite component according to claim 1, wherein the lap joint connects the first segment with the second segment along a predetermined length of the composite component.

6. The lap jointed flanged composite component according to claim 1, further comprising:
a transition region formed between the butt joint and the lap joint.

7. The lap jointed flanged composite component according to claim 1, further comprising:
a stiffener proximate the lap joint.

8. A lap jointed flanged composite component for a gas turbine engine comprising:
a first end opposite a second end;
a first segment coupled with a second segment;
the first segment includes a first flange on at least one of the first end and the second end;
the second segment includes a second flange on at least one of the first end and the second end;
a butt joint formed at an intersection of the first flange and the second flange forming a circumferential flange with respect to an axis;
a lap joint overlapping the first segment with the second segment proximate the butt joint; and
a transition region formed between the butt joint and the lap joint.

9. The lap jointed flanged composite component for a gas turbine engine according to claim 8, wherein the first segment includes a first segment tab; the second segment includes a second segment tab; wherein the first segment tab overlaps the second segment tab within the lap joint a predetermined overlap dimension.

10. The lap jointed flanged composite component for a gas turbine engine according to claim 8, wherein at least one of the first segment includes a first segment indentation and the second segment includes a second segment indentation.

11. The lap jointed flanged composite component for a gas turbine engine according to claim 8, further comprising:
a stiffener proximate at least one of the butt joint and the lap joint.

12. The lap jointed flanged composite component for a gas turbine engine according to claim 8, wherein the transition region includes a taper region comprising a thinning of a thickness of the first segment and/or the second segment.

13. The lap jointed flanged composite component for a gas turbine engine according to claim 8, wherein the first flange and the second flange extend radially outboard from an exterior surface of each of the first segment and the second segment respectfully.

14. A process for forming a lap jointed flanged composite component for a gas turbine engine comprising:
forming a first end opposite a second end with respect to an axis;
coupling a first segment with a second segment;
forming a first flange on at least one of the first end and the second end of the first segment;
forming a second flange on at least one of the first end and the second end of the second segment;
combining the first flange and the second flange together at a butt joint;
forming a circumferential flange with respect to the axis; and
forming a lap joint by overlapping the first segment with the second segment proximate the butt joint.

15. The process of claim 14, further comprising:
forming a transition region between the butt joint and the lap joint.

16. The process of claim 15, wherein the transition region includes a taper region comprising a thinning of a thickness of the first segment and/or the second segment.

17. The process of claim 14, further comprising:
forming the first segment with a first segment tab;
forming the second segment with a second segment tab; and
overlapping the first segment tab with the second segment tab within the lap joint a predetermined overlap dimension.

18. The process of claim 14, wherein at least one of the first segment includes a first segment indentation and the second segment includes a second segment indentation.

19. The process of claim 14, further comprising:
attaching a stiffener proximate at least one of the butt joint and the lap joint.

20. The process of claim 14, further comprising:
joining the first segment with the second segment within the lap joint with a fastener.
